(19) United States
(12) Patent Application Publication
(10) Pub. No.: US 2015/0159555 A1
(43) Pub. Date: Jun. 11, 2015

(54) INTERNAL HEATING USING TURBINE AIR SUPPLY

(71) Applicants: Chad W. Heinrich, Oviedo, FL (US); Stephen Erick Holland, Oviedo, FL (US)

(72) Inventors: Chad W. Heinrich, Oviedo, FL (US); Stephen Erick Holland, Oviedo, FL (US)

(21) Appl. No.: 14/101,384

(22) Filed: Dec. 10, 2013

(51) Int. Cl. F02C 7/224; F02C 7/18

(52) U.S. Cl. CPC F02C 7/224; F02C 7/185; F05D 2260/213; F05D 2260/232

(57) ABSTRACT

A gas turbine engine that includes a heat exchanger for heating a fuel gas using compressed air generated by the engine. The heat exchanger is positioned within an outer housing of the engine and receives the fuel gas at a first input prior to the fuel being mixed with a combustion portion of the compressed air and receives a cooling portion of the compressed air at a second input prior to the cooling portion of the compressed gas being sent to cooling flow channels. The heat exchanger also includes a first output that directs the fuel from the heat exchanger to be mixed with the combustion portion of the compressed gas and a second output that directs the cooling portion of the compressed gas to the cooling flow channels.

### BACKGROUND OF THE INVENTION

1. Field of the Invention

This invention relates generally to a system and method for heating the fuel gas provided to a gas turbine engine and, more particularly, to a system and method for using the compressed air flow from a compressor section of a gas turbine engine to increase the temperature of the fuel gas provided to the combustion section of the engine and reduce the temperature of the cooling air provided to cool components in the turbine section of the engine, such as row 1 blades and vanes.

2. Discussion of the Related Art

The world's energy needs continue to rise which provides a demand for reliable, affordable, efficient and environmentally-compatible power generation. A gas turbine engine is one known machine that provides efficient power, and often has application for an electric generator in a power plant, or engines in an aircraft or a ship. A typically gas turbine engine includes a compressor section, a combustion section and a turbine section. The compressor section provides a compressed air flow to the combustion section where the air is mixed with a fuel, such as natural gas, and ignited to create a hot working gas. The working gas expands through the turbine section and is directed across rows of blades therein by associated vanes. As the working gas passes through the turbine section, it causes the blades to rotate, which in turn causes a shaft to rotate, thereby providing mechanical work.

The temperature of the working gas is tightly controlled so that it does not exceed some predetermined temperature for a particular turbine engine design because to high of a temperature can damage various parts and components in the turbine section of the engine. However, it is desirable to allow the temperature of the working gas to be as high as possible because the higher the temperature of the working gas, the faster the flow of the gas, which results in a more efficient operation of the engine.

In certain gas turbine engine designs, a portion of the compressed air flow is also used to provide cooling for certain components in the turbine section, typically the vanes, blades and ring segments. Thus, the more cooling and/or the more efficient cooling that can be provided to these components allows the components to be maintained at a lower temperature, and thus the higher the temperature of the working gas can be. By reducing the temperature of the compressed gas, less compressed gas is required to maintain the part at the desired temperature, resulting in a higher working gas temperature and a greater power and efficiency from the engine. Further, by using less cooling air at one location in the turbine section, more cooling air can be used at another location in the turbine section. For example, in one known turbine engine design, 80% of the compressed air flow is mixed with the fuel to provide the working gas and 20% of the compressed air flow is used to cool the hot engine parts. If less of that cooling air is used at one particular location as a result of the cooling air being lower in temperature, then more cooling air can be used at other areas in the turbine section for increased cooling.

In some gas turbine engine designs, the fuel gas provided to the combustion section of the turbine engine is heated prior to being provided to the combustion section so that it burns more efficiently, which increases the efficiency and output power of the engine. For example, an electrical heater is sometimes provided separate from the engine that heats the fuel gas from ambient to a desired temperature prior to the gas being provided to the engine, where the fuel gas is then provided to each of the separate injectors in the combustion section. However, providing electrical power to operate the electric heater also acts to reduce the overall efficiency of the power plant. Thus, there is a tradeoff between providing energy to heat the fuel gas and the benefit provided by that heated fuel gas. Therefore, it would be desirable to provide heated fuel gas to the combustion section without heating the fuel gas using a separate heater.

### SUMMARY OF THE INVENTION

In accordance with the teachings of the present invention, a gas turbine engine is disclosed that includes a heat exchanger for heating a fuel using a compressed gas generated by the engine. In one non-limiting embodiment, the gas turbine engine includes a compressor section operable to produce a compressed gas and a combustion section in fluid communication with the compressor section that receives a combustion portion of the compressed gas that is mixed with the fuel and ignited to produce a hot working fluid. The engine also includes a turbine section in fluid communication with the combustion section that receives the hot working fluid, where the turbine section includes at least one row of vanes and at least one row of blades. The turbine section also includes a plurality of cooling flow channels that receive a cooling portion of the compressed gas to direct the cooling portion of the compressed gas to the vanes and blades to provide cooling. The heat exchanger is positioned within an outer housing of the engine that receives the fuel at a first input prior to the fuel being mixed with the combustion portion of the compressed gas and receives the cooling portion of the compressed gas at a second input prior to the cooling portion of the compressed gas being sent to the cooling flow channels. The heat exchanger also includes a first output that directs the fuel from the heat exchanger to the combustion section to be mixed with the combustion portion of the gas and a second output that directs the cooling portion of the compressed gas to the cooling flow channels.

Additional features of the present invention will become apparent from the following description and appended claims, taken in conjunction with the accompanying drawings.

### BRIEF DESCRIPTION OF THE DRAWINGS

FIG. 1 is a cut-away, isometric view of a gas turbine engine;

FIG. 2 is a cut-away, cross-sectional type view of a portion of the gas turbine engine; and

FIG. 3 is the cut-away, cross-sectional type view of the portion of the gas turbine engine shown in FIG. 2 and including a heat exchanger for heating the fuel.

### DETAILED DESCRIPTION OF THE EMBODIMENTS

The following discussion of the embodiments of the invention directed to a system and method for heating the fuel in a gas turbine engine is merely exemplary in nature and is in no way intended to limit the invention or its applications or uses.

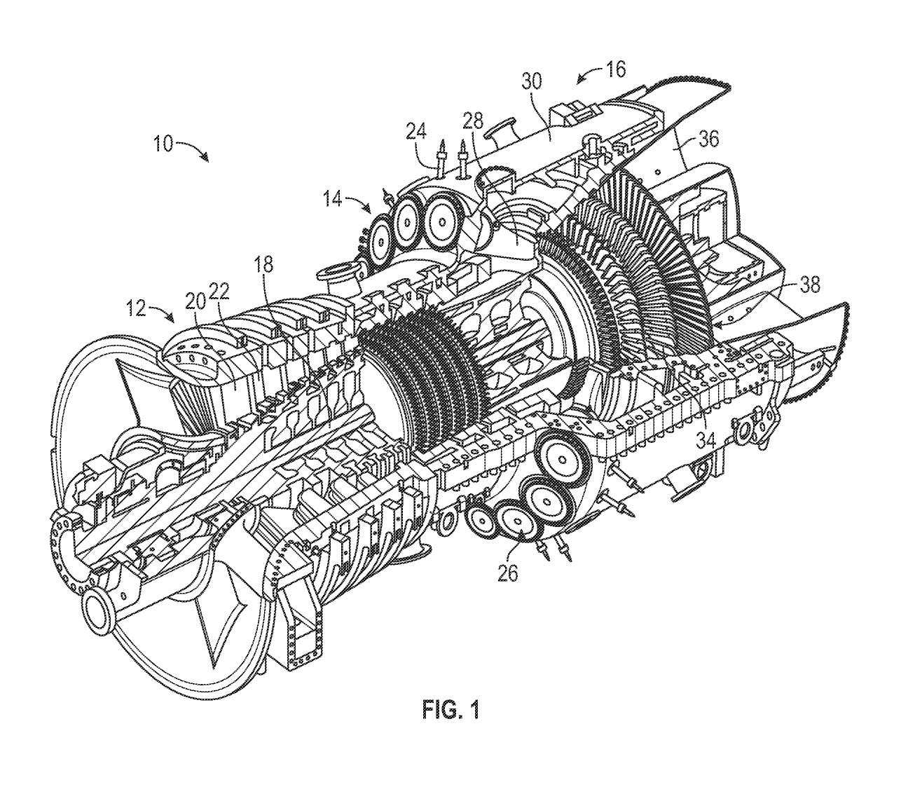

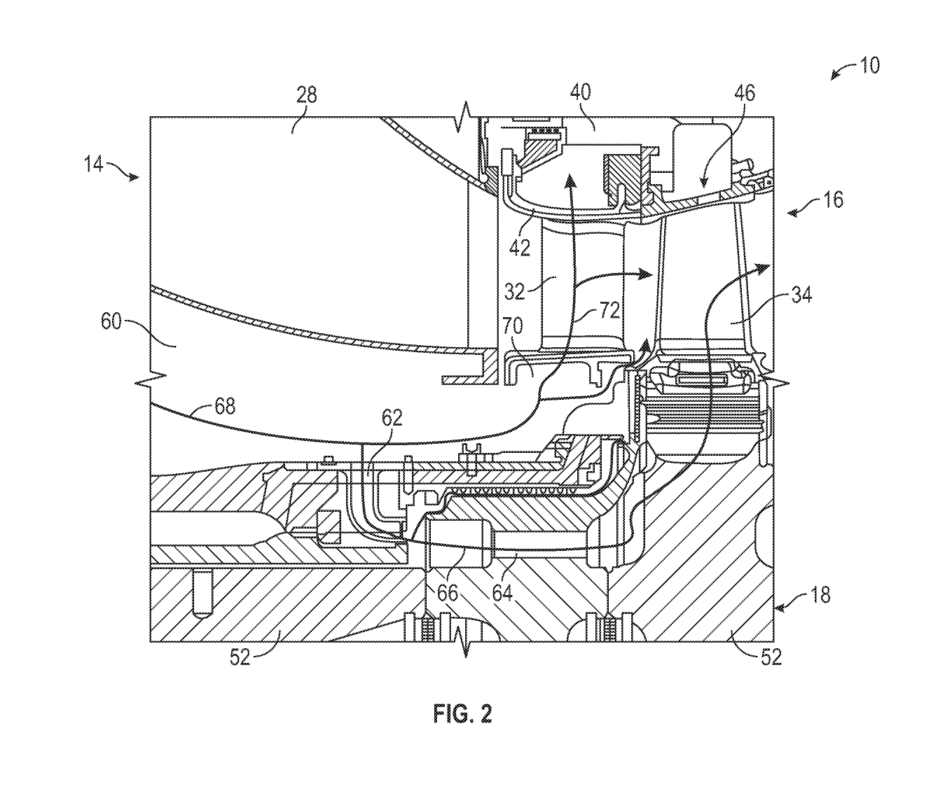

FIG. 1 is a cut-away, isometric view of a gas turbine engine 10 including a compressor section 12, a combustion section 14 and a turbine section 16 all enclosed within an outer housing 30, where operation of the engine 10 causes a central shaft or rotor 18 to rotate, thus creating mechanical work. The engine 10 is illustrated and described by way of a non-limiting example to discuss the invention referred to below. Those skilled in the art will appreciate that other gas turbine engine designs will also benefit from the invention. Rotation of the rotor 18 draws air into the compressor section 12 where it is directed by vanes 22 and compressed by rotating blades 20 to be delivered to the combustion section 14 where the compressed air is mixed with fuel, such as natural gas, and where the fuel/air mixture is ignited by an igniter 24 to create a hot working gas. More specifically, the combustion section 14 includes a number of circumferentially disposed combustors 26 each receiving the fuel that is mixed with the compressed air therein to be combusted to create the working gas, which is directed by a transition 28 to circumferentially disposed stationary vanes 32 (see FIG. 2) in the turbine section 16 to flow across circumferentially disposed rotatable turbine blades 34, which causes the turbine blades 34 to rotate, thus rotating the rotor 18. Once the working gas passes through the turbine section 16 it is output from the engine 10 as an exhaust gas through an output nozzle 36.

Each group of the circumferentially disposed stationary vanes 32 defines a row of the vanes 32 and each group of the circumferentially disposed blades 34 defines a row 38 of the blades 34. In this non-limiting embodiment, the turbine section 16 includes four rows 38 of the rotating blades 34 and four rows of the stationary vanes 32 in an alternating sequence. In other gas turbine engine designs, the turbine section 16 may include more or less rows of the turbine blades 34. It is noted that the most forward row of the turbine blades 34, referred to as the row 1 blades, and the vanes 32, referred to as the row 1 vanes, receive the highest temperature of the working gas, where the temperature of the working gas decreases as it flows through the turbine section 16. In FIG. 1, reference number 34 specifically identifies a blade in row 3 and reference number 38 specifically identifies row 4.

FIG. 2 is a cut-away, cross-sectional type view of a portion of the engine 10 where the combustion section 14 interfaces with the turbine section 16 and showing row 1 of the vanes 32 and row 1 of the blades 34. The vanes 32 are mounted to a vane carrier 40 by a mounting structure 42, where row 1 of the vanes 32 receives the hot working gas from the combustion section 14. A plurality of circumferentially disposed ring segments 46 are mounted to the vane carrier 40 and define a ring where the ring segments 46 for a particular ring are positioned adjacent to each other to form the ring, and where a separate ring is provided for each row of the blades 34. As is well understood by those skilled in the art, the ring segments 46 provide a sealing structure that allows the blades 34 to rotate in close proximity to the ring segments 46 to limit the amount of the working gas that can flow past the blades 34. The number and size of the ring segments 46 will be different for each blade row or stage, and would be different from turbine design to turbine design. FIG. 2 shows that the rotor 18 is separated into rotor disks 52.

Warm compressor air from the compressor section 12 flows into the turbine section 16 along a flow path 68 and is used to reduce the temperature of the vanes 32 and the blades 34 in the turbine section 16 so that the operating temperature of the engine 10 can be increased. In this particular turbine engine design, the compressor air flows through an annular chamber 60 in a transition area between the compressor section 12 and the combustion section 14 and into an opening 62 that allows air flow through a channel 64 to the turbine blades 34 along a flow path 66. Additionally, the turbine section 16 includes an opening 70 that allows the air to flow through and around structural elements in the turbine section 16 and through the vanes 32 along a flow path 72.

As discussed above, known gas turbine engines sometimes employ electrical heaters external to the engine 10 that heat the fuel before it is provided to the combustion section 14. The present invention proposes using the heat from the compressed air flow from the compressor section 12 on the flow path 68 that is used to reduce the temperature of the vanes 32 and the blades 34 as discussed above to increase the temperature of the fuel prior to the fuel being provided to the combustion section 14, which also reduces the temperature of the compressed air flow providing cooling of the vanes 32, the blades 34, the rotor sections 52 and/or other hot components.

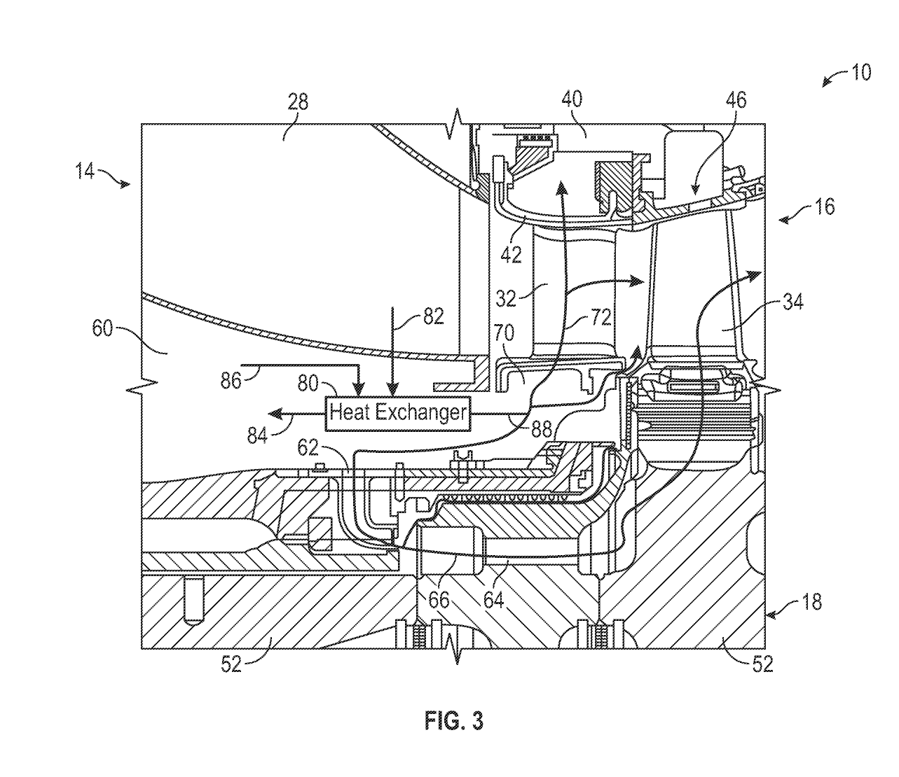

FIG. 3 is the cross-sectional type view of the portion of the turbine engine 10 shown in FIG. 2, and including a heat exchanger 80 positioned within the annular chamber 60 for this purpose. The present invention contemplates any suitable configuration of a gas/gas heat exchanger that is operable to accept the warm compressor air and the supplied temperature fuel. The heat exchanger 80 can be configured, shaped and positioned in any suitable manner that allows it to fit within the existing open areas around and between the turbine components and be circumferentially disposed around the circumference of the engine 10 in the chamber 60 or otherwise. The heat exchanger 80 can also act as a support or flow directing structure that may be able to completely replace or partly replace existing support structures, such as a vane ID support or a pre-swirler. As will be discussed further below, the heat exchanger 80 is operable to transfer heat in the compressed air flow to the supplied temperature fuel to increase the fuel in temperature, which also acts through heat transfer to reduce the temperature of the compressed air flow that is output from the heat exchanger 80. For example, in one non-limiting design, the heat exchanger 80 may increase the temperature of the fuel by about 160° C. and may reduce the temperature of the compressed airflow by about 20° C.

A fuel input line 82 is provided in the heat exchanger 80 through which the supplied temperature fuel flows and a fuel output line 84 is provided out of the heat exchanger 80 through which the heated fuel flows to be sent to the combustion section 14. The present invention contemplates any suitable plumbing, piping, hoses, seals, flow channels, orifices, structures, etc. that allow the fuel line or lines provided to the engine 10 to be routed through the outer housing 30 of the engine 10 and around and through other engine components to be coupled to the heat exchanger 80 and where the output line 84 is routed back out of the engine 10 through the housing 30 to be coupled to the combustion section 14. An air input 86 is also provided to the heat exchanger 80 that receives the compressor air used to cool the vanes 32 and the blades 34. An air output 88 from the heat exchanger 80 provides the now reduced temperature, but still warm compressor air, to the flow paths 66 and 72 that is used to cool the vanes 32 and the blades 34 in the manner discussed above. The present invention contemplates any suitable plumbing, flow channels, orifices, structures, etc. for allowing the portion of the compressor air used for cooling to be directed into the heat exchanger 80 on the air input 86 and be directed out of the heat exchanger 80 to the flow paths 66 and 72.

The present invention provides two main benefits, namely, that it is able to eliminate the need for the external heaters that were previously used in the art to heat the fuel gas to increase engine efficiency, and provides a reduction in the temperature of the cooling compressor air that results in slightly cooler vanes and blades, which can allow increased ignition temperatures for higher power and efficiency of the engine 10.

The foregoing discussion discloses and describes merely exemplary embodiments of the present invention. One skilled in the art will readily recognize from such discussion, and from the accompanying drawings and claims, that various changes, modifications and variations can be made therein without departing from the scope of the invention as defined in the following claims.

What is claimed is:

1. A gas turbine engine comprising:
a compressor section being operable to produce a compressed gas;
a combustion section in fluid communication with the compressor section that receives a combustion portion of the compressed gas, said combustion section mixing the combustion portion of the compressed gas with a fuel and combusting the mixture to produce a hot working fluid;
a turbine section in fluid communication with the combustion section, said turbine section receiving the hot working fluid, said turbine section including at least one row of vanes and at least one row of blades, said turbine section being configured to define a plurality of cooling flow channels that receive a cooling portion of the compressed gas to direct the cooling portion of the compressed gas to the at least one row of vanes and the at least one row of blades to provide cooling; and
a heat exchanger positioned within an outer housing of the gas turbine engine, said heat exchanger receiving the fuel at a first input prior to the fuel gas being mixed with the combustion portion of the compressed gas and receiving the cooling portion of the compressed gas at a second input prior to the cooling portion of the compressed gas being sent to the cooling flow channels, said heat exchanger including a first output that directs the fuel from the heat exchanger to the combustion section to be mixed with the combustion portion of the compressed gas and a second output that directs the cooling portion of the compressed gas to the cooling fluid flow channels, wherein the cooling portion of the compressed gas increases the temperature of the fuel so that the temperature of the fuel at the output of the heat exchanger is greater than the temperature of the fuel at the input of the heat exchanger and the temperature of the cooling portion of the compressed gas at the output of the heat exchanger is less than the temperature of the cooling portion of the compressed gas at the input of the heat exchanger.

2. The gas turbine engine according to claim 1 wherein the heat exchanger is positioned within a chamber at a transition area between the combustion section and the turbine section.

3. The gas turbine engine according to claim 2 wherein the heat exchanger is an annular configured heat exchanger.

4. The gas turbine engine according to claim 1 wherein the heat exchanger is also operable to provide a support or flow directing structure within the engine.

5. The gas turbine engine according to claim 1 wherein the turbine section includes a plurality of rows of vanes and a plurality of rows of blades.

6. The gas turbine engine according to claim 5 wherein the cooling portion of the compressed gas cools a first row of the vanes and a first row of the blades.

7. The gas turbine engine according to claim 1 wherein the compressed gas is air.

8. A gas turbine engine comprising an outer housing and a turbine section, said turbine section including at least one row of vanes and at least one row of blades, said turbine section further including a heat exchanger that receives a fuel prior to the fuel being mixed with a combustion portion of an air flow and receives a cooling portion of the air flow, said heat exchanger outputting a heated fuel to be mixed with the combustion portion of the air flow and a reduced temperature cooling portion of the air flow.

9. The gas turbine engine according to claim 8 wherein the heat exchanger is positioned within a chamber at a transition area between the combustion section and the turbine section.

10. The gas turbine engine according to claim 9 wherein the heat exchanger is an annular configured heat exchanger.

11. The gas turbine engine according to claim 8 wherein the heat exchanger is also operable to provide a support or flow directing structure within the engine.

12. The gas turbine engine according to claim 8 wherein the turbine section includes a plurality of rows of vanes and a plurality of rows of blades.

13. The gas turbine engine according to claim 12 wherein the cooling portion of the air flow cools a first row of the vanes and a first row of the blades.

14. A gas turbine engine comprising:
an outer housing;
a compressor section being operable to produce a compressed air flow;
a combustion section in fluid communication with the compressor section that receives a combustion portion of the compressed air flow, said combustion section mixing the combustion portion of the compressed air flow with a fuel and combusting the mixture to produce a hot working gas;
a turbine section in fluid communication with the combustion section, said turbine section receiving the hot working fluid, said turbine section including four rows of vanes and four rows of blades, said turbine section being configured to define a plurality of cooling flow channels that receive a cooling portion of the compressed air flow to direct the cooling portion of the compressed air flow to a first row of the vanes and a first row of the blades to provide cooling; and
a heat exchanger positioned within the outer housing of the gas turbine engine and within a chamber at a transition area between the combustion section and the turbine section, said heat exchanger receiving the fuel at a first input prior to the fuel being mixed with the combustion portion of the compressed air flow and receiving the cooling portion of the compressed air flow at a second input prior to the cooling portion of the compressed air flow being sent to the cooling flow channels, said heat exchanger including a first output that directs the fuel from the heat exchanger to the combustion section to be mixed with the combustion portion of the compressed air flow and a second output that directs the cooling portion of the compressed air flow to the cooling fluid flow channels, wherein the cooling portion of the compressed air flow increases the temperature of the fuel so that the temperature of the fuel at the output of the heat exchanger is greater than the temperature of the fuel at the input of the heat exchanger and the temperature of the cooling portion of the compressed air flow at the output of the heat exchanger is less than the temperature of the cooling portion of the compressed air flow at the input of the heat exchanger.

15. The gas turbine engine according to claim 14 wherein the heat exchanger is an annular configured heat exchanger.

16. The gas turbine engine according to claim 15 wherein the heat exchanger is also operable to provide a support or flow directing structure within the engine.
